(19) United States
(12) Patent Application Publication
(10) Pub. No.: US 2011/0256406 A1
(43) Pub. Date: Oct. 20, 2011

(54) Laser Weldable Thermoplastic Polyester Composition

(75) Inventors: Tony Farrell, Bergen op Zoom (NL); Johannes Hubertus G.M. Lohmeijer, Ede (NL)

(73) Assignee: SABIC Innovative Plastics IP B.V., Bergen op Zoom (NL)

(21) Appl. No.: 13/100,914

(22) Filed: May 4, 2011

Related U.S. Application Data
(63) Continuation-in-part of application No. 13/005,787, filed on Jan. 13, 2011.

(51) Int. Cl. B32B 27/08; C08K 3/30; C08K 7/14; C08L 69/00; C08L 67/02; B32B 37/04; C08K 3/34

(52) U.S. Cl. 428/412; 156/272.8; 428/430; 428/446; 428/454; 428/480; 524/423; 524/449; 524/451; 524/456; 524/537; 524/539

(57) ABSTRACT

A composition for laser welding which comprises (a) 35.5 to 80 weight percent of a non-amorphous polymer selected from the group consisting of poly(butylene terephthalate), poly(ethylene terephthalate), poly(butylene terephthalate) copolymer, poly(ethylene terephthalate) copolymer, and combinations thereof; (b) 10 to 24.5 weight percent of an amorphous polymer selected from a poly(ester) copolymer, a poly(ester-carbonate), or a combination thereof; and (c) 10 to 40 weight percent of a filler selected from the group consisting of talc, mica, barium sulphate, at least one form of glass, and a combination thereof. This composition is further compounded with (d) 0-5 parts by weight of an antioxidant, mold release agent, stabilizer, or a combination thereof based upon 100 parts by weight of the combination of the non-amorphous polymer, the amorphous polymer and the filler.

### CROSS-REFERENCE TO RELATED APPLICATION

This application is a continuation-in-part and claims priority to U.S. Ser. No. 13/005,787, filed Jan. 13, 2011.

### BACKGROUND

This disclosure relates to laser weldable thermoplastic compositions of polybutylene terephthalate or polyethylene terephthalate, methods of manufacture, and articles thereof.

Polybutylene terephthalate (PBT) is a strong and highly crystalline synthetic resin similar in structure to polyethylene terephthalate (PET). The mechanical properties of the two materials are also similar. However, PBT has a lower melting point (223° C. [433° F.]) than PET (255° C. [491° F.]), so it can be processed at lower temperatures. This property, combined with its excellent flow when molten and its rapid crystallization upon cooling, makes PBT highly suitable for injection-molding into solid parts. Either unmodified or reinforced with glass fibers or mineral fillers, it is used in numerous applications, especially electrical and small machine parts, owing to its excellent electrical resistance, surface finish, and toughness. Additionally, products that incorporate (semi-) crystalline resins can offer thermal resistance in applications that are subjected to short term high heat exposure. In the electrical and automotive industry, typical applications include lamp enclosures/bezels, connectors and circuit breakers. The Vicat softening temperature is widely used to provide an accurate measure of the thermal properties of engineering thermoplastics. The introduction of fillers to a thermoplastic resin composition causes the Vicat temperature to rise, which enhances the temperature resistance.

Thermoplastic compositions are often used in the manufacture of products requiring the joining of separate previously-formed articles, such as through laser-welding. Near-infrared (NIR) laser-welding of two polymer articles by transmission welding requires one of the polymer articles to be at least partially transparent to laser light, and the other to absorb a significant amount of the laser light. An additional key requirement is that there is good physical contact between the parts during a welding process; a smooth surface is beneficial in this respect. The laser passes through the first laser-transparent layer and is absorbed by the second polymer layer, generating heat in the exposed area. External pressure is applied to ensure uninterrupted contact and heat conduction between the parts resulting in the melting of both the absorbing and the transmitting polymers, thus generating a weld at the interface.

The level of NIR transmission in the upper part should allow sufficient laser density at the interface to facilitate effective welding. Otherwise, the joining of the two materials by laser transmission welding is either impossible or restricted to slow scan speeds, which is not very attractive as it lengthens the part assembly cycle time. Crystalline, or partially crystalline materials, such as PBT, are materials that can easily disperse the incoming radiation and thus have low laser beam transmissivity. Consequently, the extent of the laser energy at the joining interface is dramatically diminished and the adhesion between the two layers is reduced. Scattering effects are greatly enhanced when fillers such as glass fibers are present especially when the upper layer thickness is greater than 1 mm. Therefore, the laser-welding of crystalline material and particularly glass filled versions, is restricted if not impossible in a lot of cases. Additionally, the internal scattering of the laser in the first (upper) part can bring about a rise in temperature, especially in thick walled parts. It is therefore beneficial to have high thermal resistance in the laser transparent part to eliminate any mobility and distortion in the area of the join as this could lead to weld instabilities or part rupture.

The objective of the present invention is therefore to increase the transmission level of filled (semi-) crystalline resin based compositions in the area of the laser light thereby facilitating the joining of such materials by a laser welding process while still retaining the excellent thermal properties required for weld stability and use in the aforementioned applications.

### SUMMARY

The above-described challenges in achieving high NIR transmission laser-weldable thermoplastics are overcome according to the several embodiments disclosed herein. In one embodiment, a composition of the present invention comprises (a) 35.5 to 80 weight percent of a non-amorphous polymer selected from the group consisting of poly(butylene terephthalate), poly(ethylene terephthalate), poly(butylene terephthalate) copolymer, poly(ethylene terephthalate) copolymer, and combinations thereof; (b) 10 to 24.5 weight percent of an amorphous polymer selected from a poly(ester) copolymer, a poly(ester-carbonate), or a combination thereof; and (c) 10 to 40 weight percent of a filler selected from the group consisting of talc, mica, wollastonite, barium sulfate, at least one form of glass, and a combination thereof. Preferably, the filler is a glass fiber. This composition is further compounded with (d) 0-5 parts by weight of an antioxidant, mold release agent, stabilizer, or a combination thereof based upon 100 parts by weight of the combination of the non-amorphous polymer, the amorphous polymer and the filler.

In another embodiment, articles comprising the above compositions are disclosed herein. Articles molded from the composition of the present invention, having a thickness of 2 mm, shall have a near infrared transmission at 960 nanometers of greater than 30 percent and a Vicat softening temperature of at least 170° C.

The present invention also includes a method of manufacturing a composition comprising melt blending a composition of the present invention.

The present invention further includes a method of manufacture of an article comprising forming, extruding, casting, or molding a melt of a composition of the present invention as disclosed herein.

The present invention further includes a molded article for laser welding comprising an extruded composition of the present invention.

Also disclosed is a process for welding a first article comprising a laser light transparent composition of the present invention to a second thermoplastic article, which is laser light absorbing, the first article being in physical contact with the second thermoplastic article, the process comprising applying laser radiation to the first article, wherein the radiation passes through the first article and the radiation is absorbed by the second article and sufficient heat is generated to weld the first article to the second article.

Further disclosed is a laser welded, molded article comprising:

a first layer comprising a copolymer composition comprising a laser light transparent composition of the present invention;

a second layer comprising a laser light absorbing thermoplastic polymer; and

a laser welded bond between the first layer and the second layer.

The above described and other features and advantages will become more apparent by reference to the following figures and detailed description.

### DETAILED DESCRIPTION

Compounds are described herein using standard nomenclature. The singular forms “a,” “an,” and “the” include plural referents unless the context clearly dictates otherwise. All references are incorporated herein by reference. The term “combination thereof” means that one or more of the listed components is present, optionally together with one or more like components not listed. Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations. The endpoints of all ranges reciting the same characteristic or component are independently combinable and inclusive of the recited endpoint.

A composition of the present invention for laser welding is useful for forming molded, laser transmissive articles and, alternatively, for forming molded, laser absorbing articles. The present composition contains a 35.5-80 weight percent of a crystalline or semi-crystalline polymer, 10-24.5 weight percent of an amorphous polymer and 10-40 weight percent of a filler.

Surprisingly, in the composition of the present invention, it was found for certain crystalline or semi-crystalline polymers, that combination with certain amorphous polymers and fillers dramatically improved the transparency of the crystalline or semi-crystalline polymers to NIR laser light, thereby facilitating laser welding at faster weld speeds of articles molded from the crystalline or semi-crystalline polymers while concurrently maintaining a high Vicat softening temperatures, thereby enhancing resistance to thermal softening of the thermoplastic material. The compositions for laser welding of the present invention also achieved high weld strength without significantly impairing the physical properties of the compositions, as compared to the pure crystalline or partially crystalline compositions. In particular, the compositions of the present invention exhibited high NIR transparency (800-1500 nm) as represented by a 30 percent or more transmission at 960 nanometers and a Vicat softening temperature of at least 170° C. Surprisingly, parts molded from the composition of the present invention additionally exhibited low surface roughness thereby allowing better contact between the surfaces to be joined.

The composition of the present invention further includes a crystalline or semi-crystalline polymer. As used herein a “crystalline” polymer contains only crystalline domains and a “semicrystalline” polymer comprises one or more crystalline domains and one or more amorphous domains. Hereinafter, the term “non-amorphous polymer” means a crystalline or semi-crystalline polymer.

The non-amorphous polymer of the present invention is selected from poly(butylene terephthalate), poly(ethylene terephthalate), poly(butylene terephthalate) copolymers, poly(ethylene terephthalate) copolymers, and combinations thereof. The poly(butylene terephthalate), poly(ethylene terephthalate), poly(butylene terephthalate) copolymers, and poly(ethylene terephthalate) copolymers comprise repeating units of formula (1):

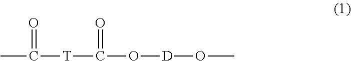

wherein T is a residue derived from a terephthalic acid or chemical equivalent thereof, and D is a residue derived from polymerization of an ethylene glycol, butylene diol, specifically 1,4-butane diol, or chemical equivalent thereof. Chemical equivalents of diacids include dialkyl esters, e.g., dimethyl esters, diaryl esters, anhydrides, salts, acid chlorides, acid bromides, and the like. Chemical equivalents of ethylene diol and butylene diol include esters, such as dialkylesters, diaryl esters, and the like.

In addition to units derived from a terephthalic acid or chemical equivalent thereof, and ethylene glycol or a butylene diol, specifically 1,4-butane diol, or chemical equivalent thereof, other T and/or D units can be present in the polyester, provided that the type or amount of such units do not significantly adversely affect the desired properties of the thermoplastic compositions.

Examples of aromatic dicarboxylic acids include 1,4-naphthalenedicarboxylic acid, 1,5-naphthalenedicarboxylic acid, 2,6-naphthalenedicarboxylic acid, and combinations comprising at least one of the foregoing dicarboxylic acids. Exemplary cycloaliphatic dicarboxylic acids include norbornene dicarboxylic acids, 1,4-cyclohexanedicarboxylic acids, and the like. In a specific embodiment, T is derived from a combination of terephthalic acid and isophthalic acid wherein the weight ratio of terephthalic acid to isophthalic acid is 99:1 to 10:90, specifically 55:1 to 50:50.

Examples of C₆₋₁₂ aromatic diols include, but are not limited to, resorcinol, hydroquinone, and pyrocatechol, as well as diols such as 1,5-naphthalene diol, 2,6-naphthalene diol, 1,4-naphthalene diol, 4,4′-dihydroxybiphenyl, bis(4-hydroxyphenyl)ether, bis(4-hydroxyphenyl) sulfone, and the like, and combinations comprising at least one of the foregoing aromatic diols.

Exemplary C₂₋₁₂ aliphatic diols include, but are not limited to, straight chain, branched, or cycloaliphatic alkane diols such as propylene glycol, i.e., 1,2- and 1,3-propylene glycol, 2,2-dimethyl-1,3-propane diol, 2-ethyl-2-methyl-1,3-propane diol, 1,4-but-2-ene diol, 1,3- and 1,5-pentane diol, dipropylene glycol, 2-methyl-1,5-pentane diol, 1,6-hexane diol, dimethanol decalin, dimethanol bicyclooctane, 1,4-cyclohexane dimethanol, including its cis- and trans-isomers, triethylene glycol, 1,10-decanediol; and combinations comprising at least of the foregoing diols.

These non-amorphous polymers typically can have an intrinsic viscosity, as determined in chloroform at 25° C., of 0.3 to 2 deciliters per gram, preferably 0.45 to 1.2 deciliters per gram, and a weight average molecular weight of 10,000 to 200,000 Daltons, preferably 20,000 to 100,000 Daltons as measured by gel permeation chromatography. Methods for preparing non-amorphous and amorphous polymers, and the properties of these polymers, are described in U.S. Pat. Nos. 6,599,966, 7,687,583 and 6,538,065, the teachings of which are incorporated herein by reference.

In addition to the non-amorphous polymer, the composition of the present invention also contains an amorphous polymer selected from a poly(ester) copolymer, a poly(ester-carbonate), or a combination thereof. The term “amorphous” as defined herein means a polyester that does not exhibit a substantial crystalline melting point when scanned by differential scanning calorimetry (DSC) at a rate of 20° C./minute.

In one embodiment of the present invention, the amorphous polymer is an amorphous polyester copolymer made up of two or more different types of polyester repeating units that are known in the art.

Typically the copolyester of the present invention is prepared from the previously described dicarboxylic acids and diols. Preferably, at least a portion of the copolyester is derived from cyclohexanedicarboxylic acid, terephthalic acid or isophthalic acid. Methods for preparing copolyesters, and their properties, are described in U.S. Pat. Nos. 7,026,027, 5,705,575, 7,834,127 and 7,687,594, the teachings of which are incorporated herein by reference.

A specific amorphous (poly)ester copolymer includes copolyesters derived from a mixture of linear aliphatic diols, in particular ethylene glycol, butylene glycol, poly(ethylene glycol) or poly(butylene glycol), together with cycloaliphatic diols such as 1,4-hexane diol, dimethanol decalin, dimethanol bicyclooctane, 1,4-cyclohexane dimethanol and its cis- and trans-isomers, 1,10-decane diol, and the like. The ester units comprising the linear aliphatic or cycloaliphatic ester units can be present in the polymer chain as individual units, or as blocks of the same type of units. In an embodiment, polyesters of this type are poly(1,4-cyclohexanedimethylene terephthalate)-co-poly(ethylene terephthalate), known as PCTG when greater than 50 mol % of the ester groups are derived from 1,4-cyclohexanedimethylene terephthalate, or PETG when less than 50 mol % of the ester groups are derived from 1,4-cyclohexanedimethylene terephthalate.

In a preferred embodiment, the amorphous polymer is a poly(ester-carbonate) copolymer comprising recurring units of formula (2)

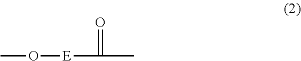

wherein E is alicyclic, aryl, carbonyl-aryl, wherein the carbonyl is attached to the oxygen or a combination thereof, and recurring polycarbonate units of formula (3):

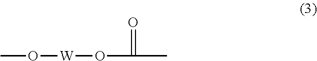

in which at least 60 percent of the total number of W groups contain aromatic organic groups and the balance thereof are aliphatic or alicyclic groups. In an embodiment, each R¹ is a C₆₋₃₀ aromatic group that contains at least one aromatic moiety. Polycarbonate units of formula (3) can be derived can be derived from a dihydroxy compound of the formula HO—W—OH, in particular a dihydroxy aromatic compound of formula (4):

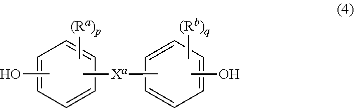

wherein R^{a} and R^{b} each represent a halogen or C₁₋₁₂ alkyl group and can be the same or different; and p and q are each independently integers of 0 to 4. Also in formula (4), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic bridging group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ alkyl group, specifically methyl, disposed meta to the hydroxy group on each arylene group. In an embodiment, X^{a} is a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

Other useful aromatic dihydroxy compounds of the formula HO—R¹—OH include compounds of formula (5)

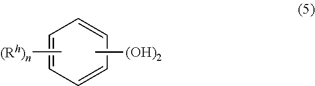

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds of formulas (4) and (5) include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 4,4′-dihydroxybenzophenone, 3,3-bis(4-hydroxyphenyl)-2-butanone, bis(4-hydroxyphenyl)ether, bis(4-hydroxyphenyl)sulfide, bis(4-hydroxyphenyl)sulfoxide, bis(4-hydroxyphenyl)sulfone, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like, as well as combinations comprising at least one of the foregoing dihydroxy compounds.

Preferably the carbonate unit is derived from bisphenol A.

In a more preferred embodiment, the poly(ester-carbonate) copolymer comprises up to three different types of ester units of formula (2) and carbonate units of formula (3) derived from bisphenol A. The relative ratio of the ester:carbonate units can vary widely, e.g., from 99:1 to 1:99.

Another specific polyester-carbonate) copolymer comprises, based on the total weight of the copolymer, 5 to 85 weight percent of carbonate units and 15 to 95 weight percent of ester units of the following formula (6) which are hereinafter referred to as arylate units,

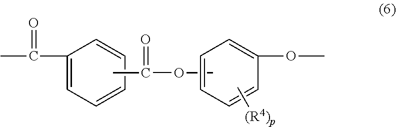

wherein each R⁴ is independently a halogen, H or a C₁₋₄ alkyl, and p is 0 to 3.

The arylate units can be derived under standard polyester preparative conditions known in the art from the reaction of a mixture of terephthalic acid and isophthalic acid or chemical equivalents thereof with compounds such as 5-methyl resorcinol, 5-ethyl resorcinol, 5-propyl resorcinol, 5-butyl resorcinol, 5-t-butyl resorcinol, 2,4,5-trifluoro resorcinol, 2,4,6-trifluoro resorcinol, 4,5,6-trifluoro resorcinol, 2,4,5-tribromo resorcinol, 2,4,6-tribromo resorcinol, 4,5,6-tribromo resorcinol, catechol, hydroquinone, 2-methyl hydroquinone, 2-ethyl hydroquinone, 2-propyl hydroquinone, 2-butyl hydroquinone, 2-t-butyl hydroquinone, 2,3,5-trimethyl hydroquinone, 2,3,5-tri-t-butyl hydroquinone, 2,3,5-trifluoro hydroquinone, 2,3,5-tribromo hydroquinone, or a combination comprising at least one of the foregoing compounds. The aromatic carbonate units in the poly(ester-carbonate) copolymers are of formula (3) as described above. Preferably, the carbonate units are derived from bisphenol A. Methods for preparing non-amorphous and amorphous polymers, and the properties of these polymers, are described in U.S. Pat. Nos. 6,599,966, 7,687,583 and 6,538,065, the teachings of which are incorporated herein by reference.

More preferably, the poly(ester-carbonate) copolymer is a poly(isophthalate-terephthalate-resorcinol ester)-co-(bisphenol A carbonate) polymer comprising repeating structures of formula (7):

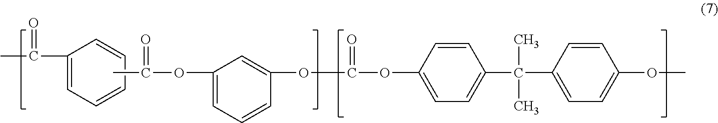

comprising, as stated above, 15 to 95 weight percent of arylate units, and 5 to 85 weight percent of carbonate units based on the total weight of copolymer. Preferably, the ratio of carbonate to arylate units is at least 1.5:1.

Most preferably, the amorphous poly(ester-carbonate) of the present invention comprises a copolymer of bisphenol A carbonate block, shown below in formula (8), and polyester blocks made of a copolymer of bisphenol A with isothalate, terephthalate or a combination of isophthalate and terephthalate shown below in formula (9).

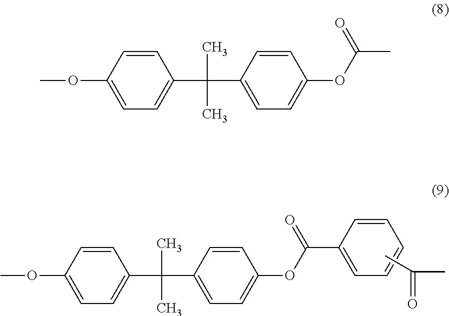

The polyester-polycarbonate copolymer comprises terminal groups derived from the reaction with a chain stopper (also referred to as a capping agent), which limits molecular weight growth rate, and so controls molecular weight in the polycarbonate. The chain stoppers are monophenolic compounds of formula (10):

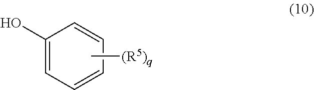

wherein each R⁵ is independently halogen, C₁₋₂₂ alkyl, C₁₋₂₂ alkoxy, C₁₋₂₂ alkoxycarbonyl, C₆₋₁₀ aryl, C₆₋₁₀ aryloxy, C₆₋₁₀ aryloxycarbonyl, C₆₋₁₀ arylcarbonyl, C₇₋₂₂ alkylaryl, C₇₋₂₂ arylalkyl, C₆₋₃₀ 2-benzotriazole, or triazine, and q is 0 to 5. As used herein, C₆₋₁₆ benzotriazole includes unsubstituted and substituted benzotriazoles, wherein the benzotriazoles are substituted with up to three halogen, cyano, C₁₋₈ alkyl, C₁₋₈ alkoxy, C₆₋₁₀ aryl, or C₆₋₁₀ aryloxy groups. Exemplary monophenolic chain stoppers of formula (10) include phenol, p-cumyl-phenol, p-tertiary-butyl phenol, hydroxy diphenyl, monoethers of hydroquinones such as p-methoxyphenol, alkyl-substituted phenols including those with branched chain alkyl substituents having 8 to 9 carbon atoms, monophenolic UV absorber such as 4-substituted-2-hydroxybenzophenone, aryl salicylate, monoesters of diphenols such as resorcinol monobenzoate, 2-(2-hydroxyaryl)-benzotriazole, 2-(2-hydroxyaryl)-1,3,5-triazines, and the like. Specific monophenolic chain stoppers include phenol, p-cumylphenol, and resorcinol monobenzoate. The type and amount of chain stopper used in the manufacture of the poly(ester-carbonate) copolymers are selected to provide copolymers having an Mw of 1,500 to 100,000 Daltons, specifically 1,700 to 50,000 Daltons, and more specifically 2,000 to 40,000 Daltons. Molecular weight determinations are performed using gel permeation chromatography, using a cross-linked styrene-divinylbenzene column, and calibrated to bisphenol A polycarbonate references. Samples are prepared at a concentration of 1 milligram per milliliter, and are eluted at a flow rate of 1.0 milliliter per minute.

The filler contained in the composition of the present invention is selected from the group consisting of talc, mica, wollastonite, barium sulfate, at least one form of glass and a combination thereof. Suitable glass forms include glass beads, glass powder, and milled glass fiber, which can be in the form of a plate, column. Where the filler is a fibrous material, the average diameter of the fibrous material can be, for example, 1 to 50 micrometers, specifically 3 to 30 μm micrometers, and the average length of the fibrous material can be, for example, 100 micrometers to 3 mm, specifically 300 micrometers μm to 1 mm, and more specifically 500 micrometers to 1 mm. Where the filler is a plate-like or a particulate, the average particle size of the plate-like or particulate filler may be, for example, 0.1 to 100 μm and specifically 0.1 to 50 micrometers (e.g., 0.1 to 10 micrometers). These fibrous, particulate and plate-like fillers may be used alone or in combination in the composition of the present invention.

In a preferred embodiment, the filler is a glass filler as known in the art, such as a glass fiber, a glass flake, a glass bead or a combination thereof. More preferably, the filler is glass fiber, particularly, a chopped strand product.

In a more preferred embodiment, a composition of the present invention for laser welding comprises (a) 43 to 76 weight percent of a poly(butylene terephthalate); (b) 11.5 to 24.5 weight percent of a poly(phthalate ester)-co-(bisphenol-A carbonate) copolymer containing at least 60% ester units; and (c) 12.5 to 32.5 weight percent of a glass fiber.

The composition of the present invention is further compounded with (d) 0-5 parts by weight of an antioxidant, mold release agent, stabilizer, or a combination thereof based upon 100 parts by weight of the combination of the non-amorphous polymer, the amorphous polymer and the filler.

Optionally, the composition of the present invention further includes a colorant, specifically either one or more colorants that do not absorb substantially in the NIR (800-1500 nm) from which a colored laser transmitting article can be molded, or one or more laser absorbing colorants from which a laser absorbing article can be molded.

Suitable examples of laser-transparent colored compositions including black can be manufactured through a selection and combination of colorants generally available in the art including but not limited to anthraquinone, perinone, quinoline, perylene, methane, coumarin, phthalimide, isoindoline, quinacridone and azomethine based dyes.

For a laser absorbing colorant, carbon black is preferred, typically in an amount of 0.01 to 10 parts by weight in comparison to the combined weight of the filler, amorphous polymer and non-amorphous polymer in the composition.

Optionally, the thermoplastic composition of the present invention can also include various other additives ordinarily incorporated with compositions of this type, with the proviso that the additives are selected so as not to significantly adversely affect the desired properties of the composition. Combinations of additives can be used. Exemplary additives include an antioxidant, thermal stabilizer, light stabilizer, ultraviolet light absorbing additive, quencher, plasticizer, mold release agent, impact modifier, antistatic agent, flame retardant, anti-drip agent, radiation stabilizer, mold release agent, or a combination thereof. Each of the foregoing additives, is used in amounts typical for thermoplastic blends, of up to 15 parts by weight percent in comparison to the combined weight of the filler, amorphous polymer and non-amorphous polymer in the composition, and preferably 0 to 5 parts by weight, except for flame retardants, which are more typically used in amounts of 1 to 10 parts by weight.

In one embodiment, the composition comprises from 0 to 5 parts by weight of a combination of an antioxidant, mold release agent, colorant, and/or stabilizer, based on the total weight of the composition.

Exemplary antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants can be used in amounts of 0.0001 to 1 weight percent, based on the total weight of the composition.

Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers can be used in amounts of 0.0001 to 1 weight percent, based on the total weight of the composition.

Mold release agents include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate, the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; combinations of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of 0.001 to 1 weight percent, specifically 0.01 to 0.75 weight percent, and more specifically 0.1 to 0.5 weight percent, based on the total weight of the composition.

Exemplary impact modifiers include a natural rubber, low-density polyethylene, high-density polyethylene, polypropylene, polystyrene, polybutadiene, styrene-butadiene, styrene-butadiene-styrene, styrene-ethylene-butadiene-styrene, acrylonitrile-butadiene-styrene, acrylonitrile-ethylene-propylene-diene-styrene, styrene-isoprene-styrene, methyl methacrylate-butadiene-styrene, a styrene-acrylonitrile, an ethylene-propylene copolymer, an ethylene-propylene-diene terpolymer, an ethylene-methyl acrylate copolymer, an ethylene-ethyl acrylate copolymer, an ethylene-vinyl acetate copolymer, an ethylene-glycidyl methacrylate copolymer, a polyethylene terephthalate-poly(tetramethyleneoxide)glycol block copolymer, a polyethylene terephthalate/isophthalate-poly(tetramethyleneoxide)glycol block copolymer, a silicone rubber, or a combination comprising at least one of the foregoing impact modifiers.

The thermoplastic composition can be manufactured by methods generally available in the art. For example, one method of manufacturing a thermoplastic composition comprises melt blending the components of the composition. More particularly, the powdered thermoplastic polymer components and other optional additives (including stabilizer packages, e.g., antioxidants, heat stabilizers, mold release agents, and the like) are first blended, in a HENSCHEL-Mixer® high speed mixer. Other low shear processes such as hand mixing can also accomplish this blending. The blend is then fed into the throat of an extruder via a hopper. Alternatively, one or more of the components can be incorporated into the composition by feeding directly into the extruder at the throat and/or downstream through a sidestuffer. Alternatively, any desired additives can also be compounded into a masterbatch, in particular the white pigment, and combined with the remaining polymeric components at any point in the process. The extruder is generally operated at a temperature higher than that necessary to cause the composition to flow. The extrudate is immediately quenched in a water batch and pelletized. Such pellets can be used for subsequent molding, shaping, or forming. In specific embodiments, a method of manufacturing a thermoplastic composition comprises melting any of the above-described compositions to form the laser-weldable composition.

Shaped, formed, or molded articles comprising the compositions are also provided. In one embodiment, an article is formed by extruding, casting, blow molding, or injection molding a melt of the thermoplastic composition. The article can be in the form of a film or sheet.

In an embodiment, the article is suitable for laser welding. A process for welding a first article comprising the above compositions to a second thermoplastic article comprises physically contacting at least a portion of a surface of the first article with at least a portion of a surface of the second thermoplastic article, applying laser radiation to the first article, wherein the radiation passes through the first article and the radiation is absorbed by the second article and sufficient heat is generated to weld the first article to the second article.

The second thermoplastic article can comprise a wide variety of thermoplastic polymer compositions that have been rendered laser absorbing by means known to those of skill in the art including the use of additives and/or colorants such as but not limited to carbon black. Exemplary polymer compositions can include but are not limited to, olefinic polymers, including polyethylene and its copolymers and terpolymers, polybutylene and its copolymers and terpolymers, polypropylene and its copolymers and terpolymers; alpha-olefin polymers, including linear or substantially linear interpolymers of ethylene and at least one alpha-olefin and atactic poly(alpha-olefins); rubbery block copolymers; polyamides; polyimides; polyesters such as poly(arylates), poly(ethylene terephthalate) and poly(butylene terephthalate); vinylic polymers such as polyvinyl chloride and polyvinyl esters such as polyvinyl acetate; acrylic homopolymers, copolymers and terpolymers; epoxies; polycarbonates, polyester-polycarbonates; polystyrene; poly(arylene ethers), including poly(phenylene ether); polyurethanes; phenoxy resins; polysulfones; polyethers; acetal resins; polyoxyethylenes; and combinations thereof. More particularly, the polymers are selected from the group consisting of polyethylene, ethylene copolymers, polypropylene, propylene copolymers, polyesters, polycarbonates, polyester-polycarbonates, polyamides, poly(arylene ether)s, and combinations thereof. In a specific embodiment, the second article comprises an olefinic polymer, polyamide, polyimide, polystyrene, polyarylene ether, polyurethane, phenoxy resin, polysulfone, polyether, acetal resin, polyester, vinylic polymer, acrylic, epoxy, polycarbonate, polyester-polycarbonate, styrene-acrylonitrile copolymers, or a combinations thereof. More specifically, the second article comprises a polycarbonate homopolymer or copolymer, polyester homopolymer or copolymer, e.g., a poly(carbonate-ester) and combinations thereof.

In one embodiment the second article comprises a glass-filled non-amorphous polymer composition that has been rendered laser absorbing. Compositions and methods for rendering such composition laser absorbing are known to those of skill in the art.

In another embodiment the second article comprises a glass-filled combination of a non-amorphous composition and an amorphous thermoplastic poly(ester) copolymer, poly(ester-carbonate) or combination thereof that has been rendered laser absorbing. Compositions and methods for rendering such composition laser absorbing are known to those of skill in the art.

The thermoplastic composition of the second article can further comprise a near-infrared absorbing material (a material absorbing radiation wavelengths from 800 to 1500 nanometers) that is also not highly absorbing to visible light (radiation wavelengths from 350 nanometers to 800 nanometers). In particular the near-infrared absorbing material can be selected from organic dyes including polycyclic organic compounds such as perylenes, nanoscaled compounds metal complexes including metal oxides, mixed metal oxides, complex oxides, metal-sulphides, metal-borides, metal-phosphates, metal-carbonates, metal-sulphates, metal-nitrides, lanthanum hexaboride, cesium tungsten oxide, indium tin oxide, antimony tin oxide, indium zinc oxide, and combinations thereof. In one embodiment, the near-infrared material has an average particle size of 1 to 200 nanometers. Depending on the particular NIR absorbing material used, the NIR absorbing material can be present in the thermoplastic composition of the second article in an amount from 0.00001 to 5 weight percent of the composition. Suitable amounts provide effective NIR absorption, and are readily determined by one of ordinary skill in the art without undue experimentation. Lanthanum hexaboride and cesium tungsten oxide, for example, can be present in the composition in an amount from 0.00001 to 1 weight percent, still more specifically 0.00005 to 0.1 weight percent, and most specifically 0.0001 to 0.01 weight percent, based on total weight of the laser-weldable composition.

Also disclosed are laser-welded articles comprising the inventive thermoplastic compositions as described above in a first component, laser-welded to a second component comprising a second thermoplastic composition as described above.

The compositions and methods are further illustrated by the following Examples, which do not limit the claims.

### EXAMPLES

### Materials

The materials shown in Table 1 were used in the Examples below.

TABLE 1

| COMPONENT | CHEMICAL DESCRIPTION | SOURCE |
|---|---|---|
| PBT 195 | Poly(1,4-butylene terephthalate), (M_{w} = 66,000 | SABIC Innovative |
| | g/mol, using polystyrene standards) | Plastics |
| PBT-315 | Poly(1,4-butylene terephthalate), (M_{w} = 115,000 | SABIC Innovative |
| | g/mol, using polystyrene standards) | Plastics |
| PET | Poly(ethylene terephthalate) (IV > 0.55) | ACCORDIS |
| High IV PET | Poly(ethylene terephthalate) (IV > 0.75) | EASTMAN |
| PC 105 | Amorphous bisphenol A polycarbonate | LEXAN ®, SABIC |
| | homopolymer (M_{w} = 30,000 g/mol, using | Innovative Plastics |
| | polystyrene standards) | |
| PC 125 | Amorphous bisphenol A polycarbonate | LEXAN ®, SABIC |
| | homopolymer (M_{w} = 23,000 g/mol, using | Innovative Plastics |
| | polystyrene standards) | |
| 20:80 ITR-PC | Amorphous poly(20 wt % isophthalate-terephthalate- | SABIC Innovative |
| | resorcinol ester)-co-(80 wt % bisphenol A carbonate) | Plastics |
| | copolymer (M_{w} = 60,000 g/mol, using polystyrene | |
| | standards) | |
| 40:60 ITR-PC | Amorphous poly(40 mol % isophthalate- | SABIC Innovative |
| | terephthalate-resorcinol ester)-co-(60 mol % | Plastics |
| | bisphenol-A carbonate) copolymer (Mw = 25,000 | |
| | g/mol, PS standards) | |
| 90:10 ITR-PC | Amorphous poly (90 weight percent isophthalate- | SABIC Innovative |
| | terephthalate-resorcinol)-co-(10 weight percent | Plastics |
| | bisphenol-A carbonate) copolymer (M_{w} = 40,000 | |
| | g/mol, using polystyrene standards) | |
| PPC-resin | Amorphous poly(ester-carbonate), bisphenol A | SABIC Innovative |
| | based poly(phthalate-carbonate) containing 80% | Plastics |
| | isophthalate-terephthalate ester units (M_{w} = 28,500 | |
| | g/mol, using polystyrene standards) | |
| PCE-resin | Amorphous poly(ester-carbonate bisphenol A based | SABIC Innovative |
| | poly(phthalate-carbonate) containing 60% | Plastics |
| | isophthalate-terephthalate ester units (M_{w} = 28,000 | |
| | g/mol, using polystyrene standards) | |
| PE (ld) | Poly(ethylene), low density | SABIC Innovative |
| | | Plastics |
| Solvent Green 3 | MACROLEX ™ GREEN 5B | Lanxess |
| Solvent Red 135 | MACROLEX ™ Red EG | Lanxess |
| AO1076 | Octadecyl (3,5-di-tert-butyl-4- | IRGANOX 1076, |
| | hydroxyphenyl)propionate | Ciba Specialty |
| | | Chemicals |
| AO1010 | Pentaerythritol tetrakis(3,5-di-tert-butyl-4- | IRGANOX 1010, |
| | hydroxyhydrocinnamate) | Ciba Specialty |
| | | Chemicals |
| Glass fiber | SiO₂ - fibrous glass | Nippon Electric |
| | | Glass |
| MZP | Monozinc phosphate-2-hydrate | Chemische Fabriek |
| ECN-EEA | Epoxy cresol novolac resin in ethylene-ethyl | Industrial Plastics |
| | acrylate copolymer | Group |
| PETS | Pentaerythritol tetrastearate | Lonza, Inc. |
| Sodium acetate | Anhydrous sodium acetate | Quaron |

### Techniques and Procedures

### Sample Processing.

The samples containing PBT were prepared by melt extrusion on a Werner & Pfleiderer 25 mm twin screw extruder, using a nominal melt temperature of 250 to 275° C., 25 inches (635 mm) of mercury vacuum and 300 rpm. The extrudate was pelletized and dried at 110° C. for 3 hours.

The samples containing PET were prepared by melt extrusion on a Werner & Pfleiderer 25 mm twin screw extruder, using a nominal melt temperature of 270 to 290° C., 25 inches (635 mm) of mercury vacuum and 300 rpm. The PET samples were dried at 120° C. for 4 hours

Test specimens were produced from the dried pellets and were injection molded at nominal temperatures of 250 to 290° C. for PBT based samples and 270 to 290° C. for PET samples.

### Test Methods.

The laser-welded test pieces were sawn into strips having, e.g., a width of 15 mm or 20 mm, and the tensile strength of the weld was determined by clamping the test pieces and applying a force across the welded area at a rate of 5 mm/minute using a tensile tester (Lloyd draw bench: LR30K). The weld strength is calculated as the maximum load at break divided by the area of the weld, which is calculated as the width of the weld (laser beam width) times the length of the weld (15 mm or 20 mm for example).

To laser weld two molded articles together, a first laser transparent, upper layer test piece (60 mm×60 mm×2 mm) molded from the specified compositions described in the tables and having a high gloss surface was overlapped on a laser absorbing, lower layer having a high gloss surface. For 20% glass filled material the lower layer was Test Sample A while for 30% glass filled materials the lower layer was Test Sample B. The overlapped area was then irradiated through the upper layer with a diode laser (960 nm) with a beam diameter of 2 mm. The maximum power output available was 120 W. The power and scanning speeds are shown in the tables.

Transmission. The near infrared (NIR) transmission data was measured on 2 mm thick molded parts and collected on a Perkin-Elmer Lambda 950 spectrophotometer at 960 nm

Tensile Strength. The laser-welded test pieces were sawn into strips having, e.g., a width of 15 mm or 20 mm. The tensile strength of the weld was determined using a tensile tester (Lloyd draw bench: LR30K) by clamping the test pieces and applying a force across the welded area at a rate of 5 mm/minute. The weld strength was calculated as the maximum load at break divided by the width of the test piece.

Surface roughness. Surface roughness profiles were measured by a Veeco Dektak 6M using a 12.5 micrometer radius tip with 3 mg stylus load. The scan length was set to 1200 micrometers, the resolution to 0.267 micrometers per second. At least four measurements per sample were carried out. Results are reported as Ra, the average roughness, defined as the arithmetic average of the absolute values of the surface height deviations measured from the mean plane.

Izod and Vicat Softening Temperatures. Izod and Vicat Softening Temperatures were determined on molded samples in accordance with the methods shown in Table 2.

TABLE 2

| | Test Standard | Default Specimen Type | Units |
|---|---|---|---|
| ISO Izod at 23° C. | ISO 180 | Multi-purpose ISO 3167 | kJ/m² |
| | | Type A | |
| ISO Izod at −30° C. | ISO 180 | Multi-purpose ISO 3167 | kJ/m² |
| | | Type A | |
| ISO Vicat Softening | ISO 306 | Bar - 80 × 10 × 4 mm | ° C. |
| Temperature | | | |

### Examples 1-4, Comparative Examples 1-6, and Test Sample A

Examples 1-4 and Comparative Examples 1-6 are based on PBT and contain 20% glass fiber as filler as shown in Table 3. The compositions were processed and tested as described above. Results are also shown in Table 3.

TABLE 3

| Component | C. 1 | C. 2 | C. 3 | C. 4 | C. 5 | C. 6 | Ex. 1 | Ex. 2 | Ex. 3 | Ex. 4 | TS A |
|---|---|---|---|---|---|---|---|---|---|---|---|
| PBT 195 | 29.4 | 29 | 20 | 29 | 25 | 43 | 30 | 35 | 42 | 45 | 36.5 |
| PBT 315 | 50.24 | 35.64 | 35.64 | 19.64 | 48.64 | 11.64 | 39.64 | 29.64 | 17.64 | 11.64 | 43.2 |
| PETS | 0.2 | 0.2 | 0.2 | 0.2 | 0.2 | 0.2 | 0.2 | 0.2 | 0.2 | 0.2 | 0.2 |
| AO1010 | 0.06 | 0.06 | 0.06 | 0.06 | 0.06 | 0.06 | 0.06 | 0.06 | 0.06 | 0.06 | |
| MZP | | 0.1 | 0.1 | 0.1 | 0.1 | 0.1 | 0.1 | 0.1 | 0.1 | 0.1 | |
| PC 125 | | 15 | 24 | 31 | | | | | | | |
| PPC-resin | | | | | 6 | 25 | 10 | 15 | 20 | 23 | |
| Carbon black | | | | | | | | | | | 0.3 |
| Glass fiber | 20 | 20 | 20 | 20 | 20 | 20 | 20 | 20 | 20 | 20 | |
| Sum | 100 | 100 | 100 | 100 | 100 | 100 | 100 | 100 | 100 | 100 | 100 |
| Properties | | | | | | | | | | | |
| Vicat (° C.) | 206 | 188 | 169 | 159 | 204 | 165 | 194 | 192 | 175 | 172 | |
| % Transmission | 21 | 28 | 32 | 37 | 24 | 82 | 32 | 49 | 69 | 72 | |
| (960 nm) | | | | | | | | | | | |

The results in Table 3 show that the glass filled copolymer blend compositions containing from greater than 56 to less than 71 weight percent of a non-amorphous thermoplastic polyester and from greater than 9 to less than 25 weight percent of an amorphous thermoplastic copolymer exhibited surprisingly high transmission values in the near infrared region, in particular a transmission of at least 30% measured at 960 mm on 2 mm thick plaques. Even more unexpected was that these high transmission levels were achieved while retaining excellent thermal properties compared to compositions that did not have an amorphous copolymer in an amount from greater than 9 to less than 25 weight percent, namely a combination of a Vicat softening temperature of at least 170° C. and a transmission of at least 30% measured at 960 mm on 2 mm thick plaques.

The results are unexpected, because the use of blends containing an amorphous polymer in combination with a non-amorphous thermoplastic resin would be expected to impair the thermal properties (Vicat) of such blends. Examples 1-4, for instance, exhibited a Vicat softening temperature and % transmission that were each greater than 170° C. and 30%, respectively. In Comparative Examples 1-6 (C1-C6), on the other hand, one or both of a Vicat softening temperature and transmission are less than 170° and 30%. These results suggest that the use of the copolymer in the indicated amounts (as compared to using the copolymer outside the indicated ranges or use of a homopolymer) imparts unexpected properties.

Certain of the 20% glass filled PBT compositions were formed into upper layers and welded as described above. Results are also shown in Table 4.

TABLE 4

| | | Speed | Max load/length |
|---|---|---|---|
| | Power (W) ^{(a)} | (mm/sec) | (N/mm) |
| C. 1 | 110 | 20 | 77 |
| | 120 | 30 | 72 |
| | 120 | 40 | 53 |
| C. 2 | 75 | 30 | 73 |
| | 85 | 40 | 70 |
| | 105 | 60 | 70 |
| C. 3 | 60 | 30 | 68 |
| | 70 | 40 | 69 |
| | 95 | 60 | 66 |
| Ex. 1 | 65 | 30 | 73 |
| | 75 | 40 | 73 |
| | 100 | 60 | 70 |
| Ex. 2 | 40 | 30 | 59 |
| | 45 | 40 | 58 |
| | 55 | 60 | 57 |

^{(a)} Maximum power output was 120 W.

The results in Table 4 show that the 20% glass filled copolymer blend compositions containing a non-amorphous thermoplastic polyester in combination with an amorphous thermoplastic copolymer in the indicated amounts (as represented by Examples 1 and 2) exhibited surprisingly consistent weld strengths across a range of laser welding speeds and required lower laser power. Hence, faster speeds and shorter part assembly cycle times are achievable.

### Examples 5-14, Comparative Examples 7-9, and Test Sample B

Examples 5-14, Comparative Examples 7-9 (C7-C9), and Test Sample B (TS B) are based on PBT and contained 30% glass fiber as filler as shown in Table 5. The compositions were processed and tested as described above. Results are also shown in Table 5.

TABLE 5

| Component | C. 7 | C. 8 | C. 9 | Ex. 5 | Ex. 6 | Ex. 7 | Ex. 8 | Ex. 9 | Ex. 10 | Ex. 11 | Ex. 12 | Ex. 13 | Ex. 14 | TS B |
|---|---|---|---|---|---|---|---|---|---|---|---|---|---|---|
| PBT 195 | 33.2 | 16.1 | 16.1 | 24.1 | 26.2 | 37.9 | 40 | 26.2 | 33.56 | 26.2 | 37.9 | 26.2 | 33.56 | 55.23 |
| PBT 315 | 36.16 | 33.46 | 23.46 | 33.26 | 28.16 | 11.66 | 5.64 | 28.16 | 16 | 28.16 | 11.66 | 28.16 | 16 | 14.37 |
| AO1010 | 0.06 | 0.06 | 0.06 | 0.06 | 0.06 | 0.06 | 0.06 | 0.06 | 0.06 | 0.06 | 0.06 | 0.06 | 0.06 | |
| Solvent | 0.17 | 0.17 | 0.17 | 0.17 | 0.17 | 0.17 | 0.17 | 0.17 | 0.17 | 0.17 | 0.17 | 0.17 | 0.17 | |
| Green 3 | | | | | | | | | | | | | | |
| Solvent Red | 0.13 | 0.13 | 0.13 | 0.13 | 0.13 | 0.13 | 0.13 | 0.13 | 0.13 | 0.13 | 0.13 | 0.13 | 0.13 | |
| 135 | | | | | | | | | | | | | | |
| Carbon | | | | | | | | | | | | | | 0.3 |
| black | | | | | | | | | | | | | | |
| Paraffin | 0.1 | 0.13 | 0.13 | 0.1 | 0.1 | 0.1 | 0.1 | 0.1 | 0.1 | 0.1 | 0.1 | 0.1 | 0.1 | 0.1 |
| MZP | | 0.1 | 0.1 | 0.1 | 0.1 | 0.1 | 0.1 | 0.1 | 0.1 | 0.1 | 0.1 | 0.1 | 0.1 | |
| Glass | 30 | 30 | 30 | 30 | 30 | 30 | 30 | 30 | 30 | 30 | 30 | 30 | 30 | 30 |
| PPC | | | | 12 | 15 | 20 | 24 | | | | | | | |
| PCE | | | | | | | | 15 | 20 | | | | | |
| ITR 90/10 | | | | | | | | | | 15 | 20 | | | |
| ITR 20/80 | | | | | | | | | | | | 15 | | |
| ITR 40/60 | | | | | | | | | | | | | 20 | |
| PC 125 | | 20 | 30 | | | | | | | | | | | |
| Sum | 100 | 100 | 100 | 100 | 100 | 100 | 100 | 100 | 100 | 100 | 100 | 100 | 100 | 100 |
| Izod: 23° C. | 56 | 51 | 51 | 59 | 59 | 49 | 45 | 54 | 47 | 56 | 50 | 54 | 44 | |
| (kJ/m²) | | | | | | | | | | | | | | |
| Izod: −30° C. | 55 | 54 | 57 | 54 | 59 | 55 | 53 | 54 | 54 | 55 | 51 | 48 | 52 | |
| (kJ/m²) | | | | | | | | | | | | | | |
| Vicat (° C.) | 214 | 183 | 158 | 202 | 199 | 183 | 176 | 193 | 173 | 197 | 174 | 186 | 170 | |
| % | 20 | 27 | 41 | 40 | 51 | 64 | 75 | 47 | 62 | 37 | 56 | 40 | 54 | |
| Transmission | | | | | | | | | | | | | | |
| (960 nm) | | | | | | | | | | | | | | |

Certain of the 30% glass filled PBT compositions were formed into upper layers and welded as described above. Results are also shown in Table 6.

TABLE 6

| Property | C. 7 | Ex. 5 | Ex. 6 | Ex. 9 | Ex. 11 | Ex. 13 |
|---|---|---|---|---|---|---|
| % Transmission | 20 | 40 | 51 | 47 | 37 | 40 |
| (960 nm) | | | | | | |
| Power (W)^{(a)} | 120 | 50 | 35 | 35 | 55 | 45 |
| Speed (mm/sec) | 50 | 50 | 50 | 50 | 50 | 50 |
| Weld Strength (N/mm) | 28 | 53 | 51 | 55 | 57 | 58 |

^{(a)}Maximum power output was 120 W.

The results in Tables 5 and 6 show that 30% glass-filled copolymer blend compositions containing a non-amorphous thermoplastic polyester in combination with an amorphous thermoplastic copolymer in the indicated amounts from 45 to less than 59 weight percent of non-amorphous thermoplastic polyester and from greater than 11 to less than 25 weight percent of an amorphous thermoplastic copolymer also exhibited high transmission values in the near IR and excellent thermal properties as compared to compositions that did not have an amorphous copolymer in these amounts. The compositions had a Vicat softening temperature of at least 170° C. and a transmission of at least 30% measured at 960 mm on 2 mm thick parts.

The results are unexpected, because the use of blends containing an amorphous polymer in conjunction with a non-amorphous thermoplastic resin would be expected to impair the thermal properties (Vicat) of such blends. The benefit of the compositions of the invention in a laser welding process is evidenced by the larger weld strength of the compositions of Example 5, Example 6, Example 9, Example 11, and Example 13, containing a non-amorphous thermoplastic polyester in combination with an amorphous thermoplastic copolymer within the bounds of the indicated amounts namely from 45 to less than 59 weight percent of non-amorphous thermoplastic polyester and from greater than 11 to less than 25 weight percent of an amorphous thermoplastic copolymer, compared to C. 7, having no amorphous poly(ester-carbonate).

The surface roughness of the glass-filled PBT compositions are shown in Table 7.

TABLE 7

| | C. 1 | Ex. 2 | C. 7 | Ex. 6 |
|---|---|---|---|---|
| Roughness(nm) | 400 | 139 | 990 | 189 |

The results in Table 7 surprisingly show that the surface roughness of the glass-filled copolymer blend compositions based on PBT in combination with an amorphous thermoplastic copolymer as exemplified by Example 2 and Example 6 was also much lower than the glass-filled blends C. 1 and C. 7, which contain only a non-amorphous thermoplastic polyester.

### Example 15 and Comparative Example 10

Example 15 and Comparative Example 10 are based on PET and contained 15% glass fiber as filler as shown in Table 7. The compositions were processed and tested as described above. Results are also shown in Table 8.

TABLE 8

| Item Description | | C. 10 | Ex. 15 |
|---|---|---|---|
| | Unit | | |
| PET | % | 83.14 | 73.14 |
| PPC-resin | % | | 10 |
| Solvent Red 135 | % | 0.17 | 0.17 |
| Solvent Green 3 | % | 0.13 | 0.13 |
| ECN-EEA | % | 0.45 | 0.45 |
| PETS | % | 0.2 | 0.2 |
| PE (ld) | % | 0.6 | 0.6 |
| Sodium Acetate | % | 0.25 | 0.25 |
| Antioxidant 1010 | % | 0.06 | 0.06 |
| Glass fiber | % | 15 | 15 |
| Sum | | 100 | 100 |
| | Mold Temp | | |
| % T at 960 nm | 60 degs | 30 | 51 |
| | 90 degs | 27 | 49 |
| Roughness (nm) | 60 degs | 1173 | 62 |
| | 90 degs | 321 | 262 |

The results in Table 8 show that glass-filled copolymer blend compositions of PET containing an amorphous polyester-carbonate within the specified amounts also exhibited high transmission values in the near IR compared to a composition that did not have an amorphous copolymer in these amounts. The compositions had a transmission of at least 30% measured at 960 mm on 2 mm thick parts.

Surprisingly it was found that the surface roughness of the glass filled blends of PET thermoplastic resin based compositions, containing low weight percent of amorphous thermoplastic copolymer resin was much lower than glass filled blends of PET thermoplastic resin based compositions without the amorphous thermoplastic copolymer. In particular, Example 15 had a smoother surface compared to Comparative Example 10 across a wide range of molding temperatures. A smoother surface serves to decrease the interruptions in contact between the layers and benefits the joining process.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A composition for laser welding, comprising:
(a) 35.5 to 80 weight percent of a non-amorphous polymer selected from the group consisting of poly(butylene terephthalate), poly(ethylene terephthalate), poly(butylene terephthalate) copolymer, poly(ethylene terephthalate) copolymer, and a combination thereof;
(b) 10 to 24.5 weight percent of an amorphous polymer selected from the group consisting of a poly(ester) copolymer, a poly(ester-carbonate), and a combination thereof;
(c) 10 to 40 weight percent of a filler selected from the group consisting of talc, mica, wollastonite, barium sulfate, at least one form of glass, and a combination thereof; and
(d) 0-5 parts by weight of an antioxidant, a mold release agent, a stabilizer, or a combination thereof, based on 100 parts by weight of the combination of the non-amorphous polymer, the amorphous polymer and the filler.

2. The composition of claim 1 wherein an article having a 2 mm thickness and molded from the composition has:
(i) a near infrared transmission at 960 nanometers of greater than 30 percent and
(ii) a Vicat softening temperature of at least 170° C.

3. The composition of claim 1 wherein the filler is a glass fiber.

4. The composition of claim 3 wherein the amorphous polymer is a poly(ester-carbonate) comprising ester units and carbonate units.

5. The composition of claim 4 wherein the carbonate units are derived from bisphenol A, resorcinol, or a combination thereof.

6. The composition of claim 4 wherein the ester units are arylate units.

7. The composition of claim 6 wherein the arylate units are derived from optionally substituted resorcinol and isophthalic acid, terephthalic acid or isophthalic acid and terephthalic acid.

8. The composition of claim 4 wherein the amorphous polymer is a poly(isophthalate-terephthalate-resorcinol ester)-co-(bisphenol-A carbonate) copolymer.

9. The composition of claim 4 wherein the ester units are present as phthalate ester units derived from polymerization of a bisphenol and an aromatic dicarboxylic acid; and the carbonate units are derived from a bisphenol.

10. The composition of claim 9 wherein the bisphenol is bisphenol A and the aromatic dicarboxylic acid is a phthalic acid.

11. The composition of claim 4 wherein the amorphous polymer is a poly(phthalate ester)-co-(bisphenol-A carbonate) copolymer.

12. The composition of claims 1-11 wherein the non-amorphous polymer is poly(ethylene terephthalate) or poly(butylene terephthalate)

13. The composition of claim 12 wherein the amorphous polymer is a poly(phthalate ester)-co-(bisphenol-A carbonate) copolymer containing at least 60% ester units.

14. The composition of claim 13 wherein the composition contains 14.5 to 23.5 weight percent of said poly(phthalate ester)-co-(bisphenol-A carbonate) copolymer.

15. The composition of claim 14 wherein the composition contains 12.5 to 32.5 weight percent of the glass fiber.

16. The composition of claim 12, further comprising at least one laser transparent colorant.

17. The composition of claims 12, further comprising 0.01 to 10 parts by weight of at least one laser absorbing colorant, based upon 100 parts by weight of the combination of the non-amorphous polymer, the amorphous polymer and the filler.

18. The composition of claim 18 wherein the colorant is carbon black.

19. The composition of claim 1 further comprising:
(a) from more than 56 to less than 71 weight percent of non-amorphous polymer, and
(b) from greater than 9 to less than 25 weight percent of amorphous polymer.

20. A composition for laser welding, comprising:
(a) 43 to 76 weight percent of a polybutylene terephthalate);
(b) 11.5 to 24.5 weight percent of a poly(phthalate ester)-co-(bisphenol-A carbonate) copolymer containing at least 60% ester units; and
(c) 12.5 to 32.5 weight percent of a glass fiber.

21. A method of manufacturing the composition of claim 1, comprising melt blending the composition.

22. A molded article for laser welding comprising an extruded composition of claim 21.

23. A process for welding a first article comprising the composition of claim 1 to a second thermoplastic article, which is laser light absorbing, at least a portion of a surface
of the first article being in physical contact with at least a portion of a surface of the second thermoplastic article, the process comprising applying laser radiation to the first article, wherein the radiation passes through the first article and the radiation is absorbed by the second article and sufficient heat is generate to weld the first article to the second article.

24. The process of claim 23, wherein the second article comprises a
thermoplastic polymer is selected from polycarbonate, polyester,
polycarbonate copolymers, polyester copolymers, and combinations thereof.

25. A laser welded, molded article comprising:
a first layer comprising a composition of claim 1 or claim 21;
a second layer comprising a laser light absorbing thermoplastic polymer; and
a laser welded bond between the first layer and the second layer.
